(19) United States
(12) Patent Application Publication
(10) Pub. No.: US 2014/0150942 A1
(43) Pub. Date: Jun. 5, 2014

(54) TIRE COMPRISING A TREAD WITH A FOAMED MATERIAL

(71) Applicants: José Merino Lopez, Clermont-Ferrand (FR); Didier Vasseur, Clermont-Ferrand (FR)

(72) Inventors: José Merino Lopez, Clermont-Ferrand (FR); Didier Vasseur, Clermont-Ferrand (FR)

(73) Assignee: COMPAGNIE GENERALE DES ETABLISSEMENTS MICHELIN, Clermont-Ferrand (FR)

(21) Appl. No.: 14/114,520

(22) PCT Filed: Apr. 24, 2012
(86) PCT No.: PCT/FR12/50900

§ 371 Date: Feb. 18, 2014

(30) Foreign Application Priority Data
Apr. 28, 2011 (FR) 1153617

(51) Int. Cl. B60C 11/03; B29D 30/06

(52) U.S. Cl. CPC B60C 11/032; B29D 30/0662
USPC 152/209.17; 264/46.4

(57) ABSTRACT

The tyre comprises a tread (14) that has a running layer (14A) made of cellular material having a thickness E and a degree of expansion of greater than or equal to 50%. The running layer (14A) comprises hollow tread pattern elements (20, 22, 26). At least 95% of the hollow tread pattern elements (20, 22, 26) each satisfy the following two conditions a) and b):
a) the tread pattern element (20, 22, 26) is separated from at least one other hollow tread pattern element (20, 22, 26) by a distance less than or equal to DP=7 mm, the separation distance between two hollow tread pattern elements (20, 22, 26) being the shortest distance between these two tread pattern elements (20, 22, 26) travelled in the cellular material,
b) the tread pattern element (20, 22, 26) has a depth at least equal to 80% of the thickness E of the running layer (14A).

This application claims benefit of the filing date of PCT/FR2012/050900 filed 24 Apr. 2012, which claims benefit of the filing date of FR 1153617 filed 28 Apr. 2011, the entire contents of each of which are incorporated herein by reference in their entirety for all purposes.

### BACKGROUND

1. Field

The present disclosure relates to the field of tires comprising a cellular material.

2. Description of Related Art

In order to improve the grip of a tire, document WO 2009/003576 or WO 2009/003577 provides a tire comprising a tread that has
an outer rubber layer, subsequently referred to as a running layer, made of cellular material, in which hollow tread pattern elements are made, and
an inner rubber layer having a hardness greater than that of the outer layer.

In order to manufacture such a tire, an uncured blank is produced comprising a mass of rubber, intended to form the running layer, in which a pore-forming agent is incorporated. Next, the blank is placed in a vulcanization mold and the blank is heated under pressure in this mold.

Under the effect of heat and pressure, a chemical reaction involving the pore-forming agent creates gas bubbles that form cells in the material, which therefore becomes cellular. The outer contour of the running layer is set by the mold. Once curing is complete, the tire is extracted from the mold.

In order for the grip and noise performances to be advantageous, it is desirable for the degree of expansion of the cellular material to be greater than or equal to 50%. This degree of expansion is obtained in a manner known per se by a person skilled in the art by choosing appropriate values of various parameters such as, in particular, the amount of pore-forming agent in the mass of rubber intended to form the running layer, the pressure, the temperature and the curing time of this mass of rubber.

With such a degree of expansion, after extracting the tire from the mold, it is observed that the shape of the running layer continues to evolve, so that this layer expands radially beyond the desired outer contour. This expansion is the result of the following two effects.

On the one hand, on leaving the mold, the volume of the cells containing the gas continues to increase, swelling the running layer beyond the contour set by the mold.

On the other hand, due to the difference in pressure between the moment when the tire is in the mold and the moment when the tire is taken out of the mold, an expansion of the running layer is observed on leaving the mold.

These two effects do not make it possible to obtain, on leaving the mold, a precise geometry of the running layer and therefore do not make it possible to obtain the desired performances of the tire.

Moreover, the gases dissolved in the cellular material have a tendency to accumulate within bubbles of relatively large size. These accumulated bubbles form large-sized cells that weaken the running layer and degrade the performances of the tire.

### SUMMARY

The objective of the disclosure is in particular to optimize the geometry and the strength of the cellular material running layer of a tire.

For this purpose, one embodiment of the invention is a tire of the type comprising a tread that has a running layer made of cellular material having
a thickness E, and
a degree of expansion of greater than or equal to 50%,
   the running layer comprising hollow tread pattern elements, characterized in that at least 95% of the hollow tread pattern elements satisfy each of the following two conditions a) and b):
a) the tread pattern element is separated from at least one other hollow tread pattern element by a distance less than or equal to DP=7 mm, the separation distance between two hollow tread pattern elements being the shortest distance between these two tread pattern elements travelled in the cellular material,
b) the tread pattern element has a depth at least equal to 80% of the thickness E of the running layer.

The conditions a) and b) impose a relatively high density of deep tread pattern elements in the running layer.

Thus, owing to embodiments of the invention, although the degree of expansion of the cellular material is greater than or equal to 50%, the density of the hollow tread pattern elements in the running layer is such that the latter make it possible to limit, or even eliminate, the geometrical variations of the running layer when the tire is taken out of the vulcanization mold. Specifically, on leaving the mold, the cellular material expands essentially in the hollow tread pattern elements which are relatively numerous (without however filling in these tread pattern elements), rather than beyond the desired outer contour. Finally, the numerous and deep tread pattern elements make it possible, during vulcanization, to discharge any excesses of gas and therefore to avoid the formation of excessively large cavities.

Thus, the tire according to an embodiment of the invention has a strong running layer, the geometry of which is controlled.

According to other optional features of the tire according to the invention:
DP=6 mm;
the hollow tread pattern elements that satisfy the conditions a) and b) form elements chosen from water evacuation channels that delimit, in the running layer, blocks of cellular material, and blind holes made in these blocks so as to open radially.

Another embodiment of the invention is a process for manufacturing a tire, in which an uncured blank of the tire is vulcanized in a mold, characterized in that, the tire that it is desired to manufacture being as defined above,
the uncured blank is provided with a mass of material, comprising a pore-forming agent, intended to form the running layer made of cellular material, and
the uncured blank is placed in a vulcanization mold comprising elements for molding the hollow tread pattern elements,
   the mold being such that at least 95% of the molding elements each satisfy the following condition:
the molding element is separated from at least one other molding element by a distance less than or equal to DM=7 mm, the separation distance between two molding elements being the shortest distance between these two molding elements travelled between these molding elements.

According to other optional features of the process according to the invention:
DM=6 mm;
the pore-forming agent comprises p,p′-oxybis(benzenesulphonyl hydrazide).

### BRIEF DESCRIPTION OF DRAWINGS

The invention will be better understood on reading the description that follows, given solely by way of example and with reference to the drawings, in which:

FIG. 1 is a perspective view with cross sections along axial and radial planes of one part of a tire according to a first embodiment of the invention;

FIG. 2 is a cross-sectional view along the plane II-II from FIG. 1;

FIG. 3 is a perspective view of one part of a vulcanization mold that makes it possible to manufacture the tire represented in FIGS. 1 and 2;

FIG. 4 is an axial cross-sectional view of the tire represented in FIGS. 1 and 2 after having been removed from the mold and after any expansion of the cellular material;

FIG. 5 is a view similar to that of FIG. 1 of one part of a tire according to a second embodiment of the invention;

FIG. 6 is a perspective view of one part of a vulcanization mold that makes it possible to manufacture the tire represented in FIG. 5.

On some of the figures that represent a tire, a marker has been indicated that comprises the axes X, Y, Z that are orthogonal to one another, corresponding to the radial X, axial Y and circumferential Z orientations of the tire.

### DETAILED DESCRIPTION OF SPECIFIC EMBODIMENTS

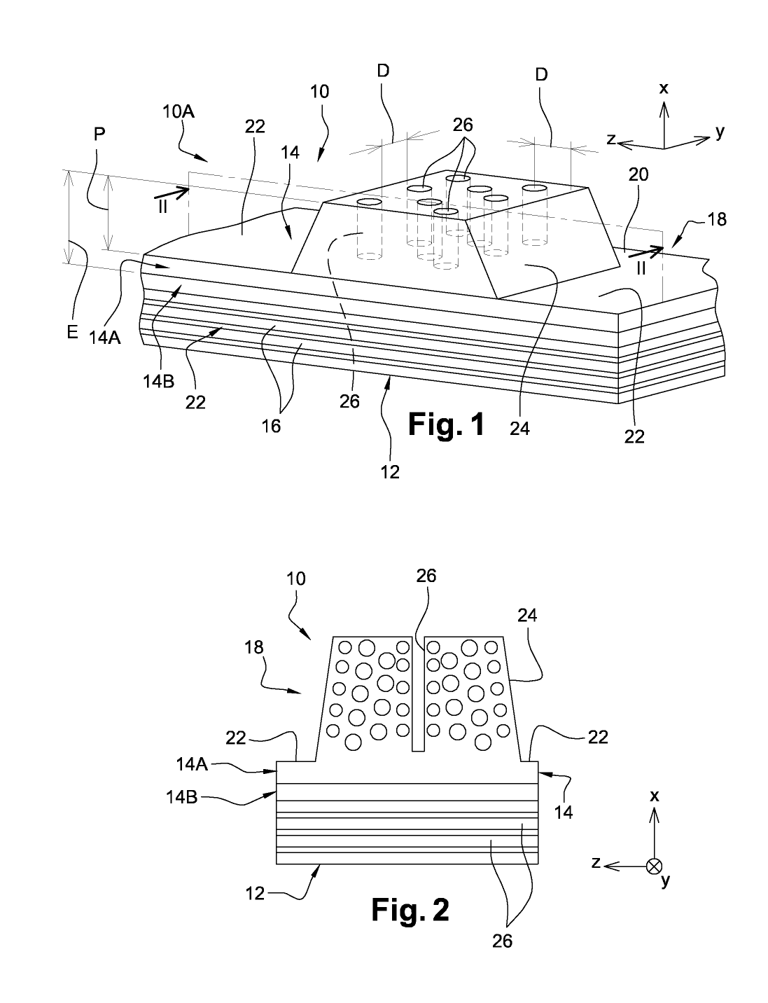

Represented in FIGS. 1 and 2 is a part of a tire according to a first embodiment of the invention, denoted by the general reference 10. In these figures, the tire 10 has a desired outer contour after its removal from a vulcanization mold.

The tire 10 comprises a reinforcement layer 12 covered by a tread 14.

The reinforcement layer 12, known per se, comprises metal or textile reinforcers 16 embedded in a conventional rubber.

The tread 14 comprises an outer, rubber layer, referred to as a running layer 14A, made of cellular material, in which hollow tread pattern elements 18 are made, and an inner rubber layer 14B having a hardness greater than that of the outer layer. The inner layer 14B is therefore inserted radially between the running layer 14A and the reinforcement layer 12.

The running layer 14A has a thickness E. The material of the running layer 14A has a degree of expansion greater than or equal to 50%. This degree of expansion can be measured using a process and means that are known per se.

The hollow tread pattern elements 18 form elements chosen from water evacuation channels 20, 22 that delimit, in the running layer 14A, blocks 24 of cellular materials, and blind holes 26, made in these blocks 24 so as to open radially.

The water evacuation channels 20,22 form, for example, circumferential grooves or substantially transverse channels.

In the tire 10 according to the first embodiment of the invention, the blind holes 26 have a general cylindrical shape.

At least 95% of the tread pattern elements 20, 22, 26 each satisfy the following conditions a) and b):
a) the tread pattern element 20, 22, 26 is separated from at least one other hollow tread pattern element by a distance less than or equal to DP=7 mm, the distance D between two hollow tread pattern elements being the shortest distance between these two tread pattern elements travelled in the cellular material,
b) the tread pattern element has a depth P at least equal to 80% of the thickness E of the running layer 14A.

Preferably, DP=6 mm.

The blind holes 26 may be uniformly distributed in the blocks 24, for example distributed in staggered rows.

The main steps of a process according to the invention for the manufacture of a tire 10 according to the first embodiment of the invention will be described below.

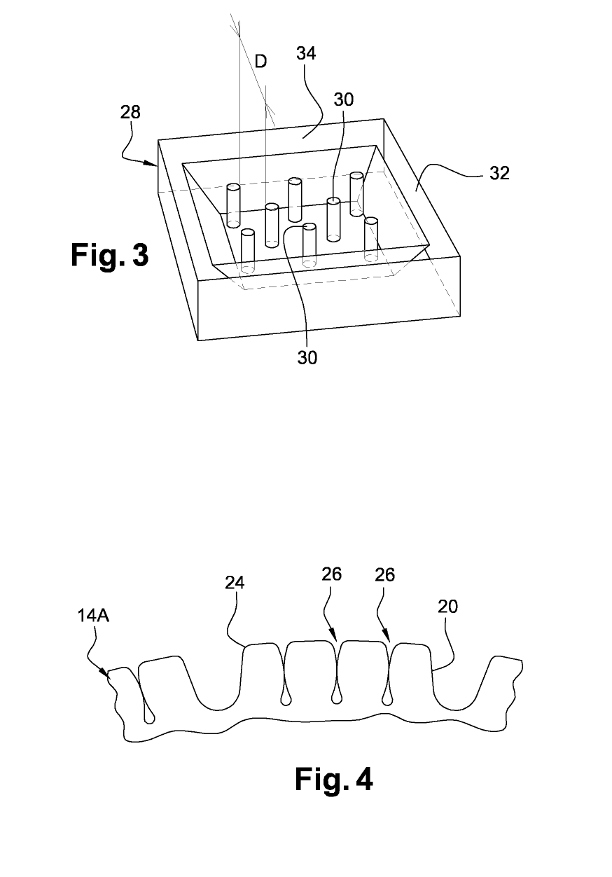

According to this process, an uncured blank of the tire is vulcanized in a vulcanization mold 28, one part of which has been represented in FIG. 3.

In this FIG. 3, the part of the mold 28 that has been represented is intended to mold a block 24. For this purpose, it especially comprises molding elements 30 in the form of cylindrical fingers, intended for the molding of the hollow tread pattern elements formed by the blind holes 26. The part of the mold 28 also comprises molding elements 32, 34 intended to participate in the molding of the hollow tread pattern elements formed by the water evacuation channels 20, 22.

The mold 28 is such that at least 95% of the molding elements each satisfy the following condition:
the molding element is separated from at least one other molding element by a distance less than or equal to DM=7 mm.

The separation distance between two molding elements is the shortest distance between these two molding elements travelled between these molding elements.

Preferably, DM=6 mm.

According to the process of the invention, firstly, the uncured blank is provided with a mass of material comprising a pore-forming agent. This mass of material is intended to form the running layer 14A made of cellular material. The pore-forming agent comprises, for example, p,p′-oxybis(benzenesulphonyl hydrazide).

Then, the uncured blank is placed in the vulcanization mold 28 comprising the elements for molding the hollow tread pattern elements.

After vulcanization, the tire is removed from the mold 28.

As is represented in FIG. 4, on leaving the mold, the cellular material of the running band 14A expands essentially in the hollow tread pattern elements, especially the elements 20, 26, which are relatively numerous (without however filling in these tread pattern elements), rather than beyond the desired outer contour as represented in FIGS. 1 and 2.

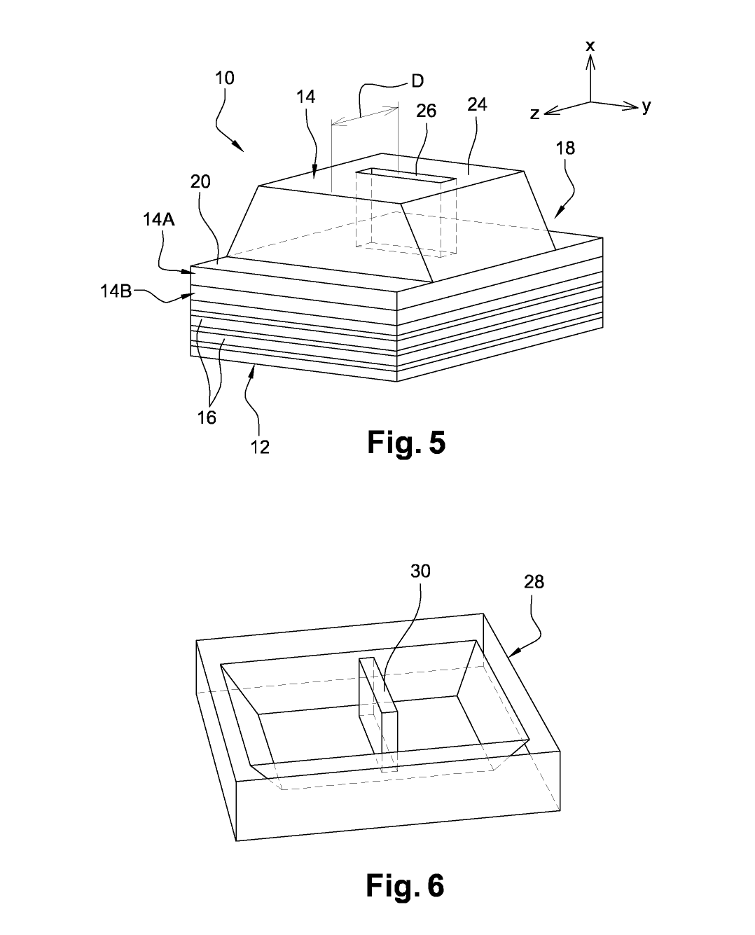

In FIG. 5, one part of tire 10 according to a second embodiment of the invention has been represented. In this FIG. 5, the elements similar to those of the preceding figures are denoted by identical references.

In this case, unlike the first embodiment of the invention, the blocks 24 may comprise at least one blind hole 26 in the general shape of a parallelepipedal slot that opens radially.

The tire 10 according to the second embodiment of the invention represented in FIGS. 5 and 6 may be manufactured in accordance with a process substantially similar to that described for the manufacture of the tire according to the first embodiment of the invention.

However, in the case of the tire according to the second embodiment of the invention, the part of the vulcanization mold 28 comprises a molding element 30 of general parallelepipedal shape complementary to that of the blind hole 26.

The invention is not limited to the embodiments described above.

In particular, it will be noted that the tread pattern elements made in the running band may have various shapes.

1. A tire of the type comprising a tread that has a running layer made of a cellular material having
a thickness E, and
a degree of expansion of greater than or equal to 50%,
the running layer comprising hollow tread pattern elements, wherein at least 95% of the hollow tread pattern elements each satisfy the following two conditions a) and b):
a) the tread pattern element is separated from at least one other hollow tread pattern element by a separation distance less than or equal to DP=7 mm, the separation distance between two hollow tread pattern elements being the shortest distance between these two tread pattern elements travelled in the cellular material,
b) the tread pattern element has a depth at least equal to 80% of the thickness E of the running layer.

2. The tire according to claim 1, in which DP=6 mm.

3. The tire according to claim 1 or 2, in which the hollow tread pattern elements satisfying the conditions a) and b) form elements chosen from:
water evacuation channels that delimit, in the running layer, blocks of cellular material, and
blind holes made in these blocks so as to open radially.

4. A process for manufacturing a tire, in which an uncured blank of the tire is vulcanized in a mold, wherein, the tire that it is desired to manufacture being according to claim 1, comprising:
providing the uncured blank with a mass of material, comprising a pore-forming agent, intended to form the running layer made of cellular material, and
placing the uncured blank in a vulcanization mold comprising molding elements for molding the hollow tread pattern elements,
wherein the mold is such that at least 95% of the molding elements each satisfy the following condition:
the molding element is separated from at least one other molding element by a distance less than or equal to DM=7 mm, the separation distance between two molding elements being the shortest distance between these two molding elements travelled between these molding elements.

5. The process according to claim 4, in which DM=6 mm.

6. The process according to claim 4 or 5, in which the pore-forming agent comprises p,p′-oxybis(benzenesulphonyl hydrazide).
